(19) United States
(12) Patent Application Publication
(10) Pub. No.: US 2016/0062967 A1
(43) Pub. Date: Mar. 3, 2016

(54) SYSTEM AND METHOD FOR MEASURING SENTIMENT OF TEXT IN CONTEXT

(71) Applicant: TLL, LLC, Santa Monica, CA (US)

(72) Inventors: Alejandro Cantarero, Santa Monica, CA (US); Benjamin Feinman Havey, Venice, CA (US); Nathan Haugo, San Francisco, CA (US)

(73) Assignee: TLL, LLC, Santa Monica, CA (US)

(21) Appl. No.: 14/469,957

(22) Filed: Aug. 27, 2014

(51) Int. Cl. G06F 17/24; G06F 17/30

(52) U.S. Cl. CPC G06F 17/241; G06F 17/30705; G06F 17/30684

(57) ABSTRACT

A system and method for determining sentiment comprising receiving textual data, identifying a context for the textual data, selecting and/or modifying a natural language processor based on the context, analyzing the textual data with the natural language processor for a sentiment determination, and storing the sentiment determination on a non-transitory computer readable medium.

### BACKGROUND

This application relates to a system and method for analyzing textual data. More specifically, a system and method that devise context specific sentiment from textual data.

A computer using a natural language processor (NLP) can conduct deep analysis on textual data. For example, through the use of NLP a computer may be able to derive sentiment from textual data. Sentiment is often determined by matching keywords that indicate a positive or negative emotion. In some cases, a NLP system may also account for additional linguistic features such as sentence structure, verbs, or actions. However, NLP may miss the larger context of the textual data which leads to incorrect sentiment determinations. For example, there may be certain statements that may indicate positive or negative sentiment depending on perspective. For Example, the textual data “the Broncos demolished the Seahawks” may be positive from the perspective of a Broncos fan but negative from the perspective of a Seahawks fan. However, current NLP engines will tag this textual data as negative due to the word “demolished” having a negative connotation.

Thus there is a need for a system and method of determining sentiment from textual data that accounts for the overall context of the textual data. The present invention satisfies this and other needs.

### SUMMARY OF THE INVENTION

In the most general aspects, the invention includes a computer implemented method for context aware sentiment analysis on textual data comprising receiving textual data; identifying a context for the textual data; selecting a natural language processor based on the context; analyzing the textual data with the natural language processor for a sentiment determination; and storing the sentiment determination on a non-transitory computer readable medium.

In another aspect, the invention includes conducting a match between the textual data and a keyword set for the context to identify a context for textual data.

In yet another aspect, the invention includes storing the sentiment determination on a non-transitory computer readable medium which comprises annotating the textual data with the sentiment determination.

In still another aspect, the invention includes storing the sentiment determination on a non-transitory computer readable medium which comprises annotating the textual data and sentiment determination with a context label.

In another aspect, the invention includes a computer implemented method for context aware sentiment analysis on textual data comprising receiving textual data; processing the textual data to determine a sentiment and associated parts of speech; identifying an object within the textual data associated with the sentiment from the associated parts of speech; matching the object to a topic; and storing topic and sentiment on a non-transitory computer readable medium.

In another aspect, the invention includes a computer implemented method for context aware sentiment analysis on textual data wherein the associated parts of speech is a verb and the object is the object of the verb.

In another aspect, the invention includes a computer implemented method for context aware sentiment analysis on textual data wherein matching the object to the topic comprises conducting a regular expression match on a keyword set for the topic.

In another aspect, the invention includes a computer implemented method for context aware sentiment analysis on textual data comprising identifying a subject within the textual data associated with the sentiment from the associated parts of speech.

In another aspect, the invention includes a computer implemented method for context aware sentiment analysis on textual data comprising matching the subject to a second topic.

In another aspect, the invention includes a computer implemented method for context aware sentiment analysis on textual data comprising changing the sentiment to a second sentiment which applies to the subject and storing the second sentiment on a non-transitory computer readable medium.

In another aspect, the invention includes a computer implemented method for context aware sentiment analysis on textual data wherein storing the second sentiment on a non-transitory computer readable medium comprises annotating the textual data with the subject and second sentiment.

In another aspect, the invention includes a computer implemented method for context aware sentiment analysis on textual data wherein the associated parts of speech is a verb or verb phrase and the object is the object of the verb phrase and the subject is the subject of the verb.

In another aspect, the invention includes a computer implemented method for context aware sentiment analysis on textual data comprising receiving textual data; identifying a context for the textual data; modifying a natural language processor for identifying sentiment in accordance with the context; determining a sentiment and associated parts of speech with the natural language processor; identifying an object within the textual data associated with the sentiment from the associated parts of speech; matching the object to a topic; and storing the topic, object, and sentiment on a non-transitory computer readable medium.

In another aspect, the invention includes a computer implemented method for context aware sentiment analysis on textual data wherein the associated parts of speech is a verb or verb phrase and the object is the object of the verb.

In another aspect, the invention includes a computer implemented method for context aware sentiment analysis on textual data wherein matching the object to a topic comprises conducting a regular expression match on a keyword set for the topic.

In another aspect, the invention includes a computer implemented method for context aware sentiment analysis on textual data comprising identifying a subject within the textual data associated with the sentiment from the associated parts of speech.

In another aspect, the invention includes a computer implemented method for context aware sentiment analysis on textual data comprising changing the sentiment to a second sentiment which applies to the subject and storing the second sentiment on a non-transitory computer readable medium.

In another aspect, the invention includes a computer implemented method for context aware sentiment analysis on textual data wherein identifying a context for the textual data comprises conducting a regular expression match between the textual data and a keyword set for the context.

In another aspect, the invention includes a computer implemented method for context aware sentiment analysis on textual data wherein storing the topic, object, and sentiment on a non-transitory computer readable medium comprises annotating the textual data with the topic, object and sentiment.

In another aspect, the invention includes a computer implemented method for context aware sentiment analysis on textual data comprising annotating the textual data with the subject.

In another aspect, the invention includes a system for determining sentiment from textual data comprising a non-transitory computer readable medium storing textual data; a processor executing instructions to identify a context for the textual data selecting a natural language processor based on the context; analyzing the data with the natural language processor and determining a sentiment based on the results of the analysis of the data; and storing the sentiment determination on the non-transitory computer readable medium.

In another aspect, the invention includes a system for determining sentiment from textual data wherein storing the sentiment determination on a non-transitory computer readable medium comprises annotating the textual data with the sentiment determination.

In another aspect, the invention includes a system for determining sentiment from textual data wherein storing the sentiment determination on a non-transitory computer readable medium comprises annotating the textual data and sentiment determination with a context label.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a flow chart illustrating an exemplary method for determining sentiment from textual data while accounting for context of the textual data.

FIG. 2 is a flow chart illustrating an exemplary method for determining context specific sentiment from textual data.

FIG. 3 is a flow chart depicting an exemplary method for determining sentiment for textual data while accounting for context and verb, subject, and object analysis.

FIG. 4 illustrates an exemplary computer system which may be programmed or configured with software commands to carry out the various embodiments of the present invention.

### DETAILED DESCRIPTION OF THE PREFERRED EMBODIMENTS

As will be described hereinafter in greater detail, the various embodiments of the present invention relate to a system and method for processing textual data. More specifically, processing textual data to determine context and sentiment based on the context. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

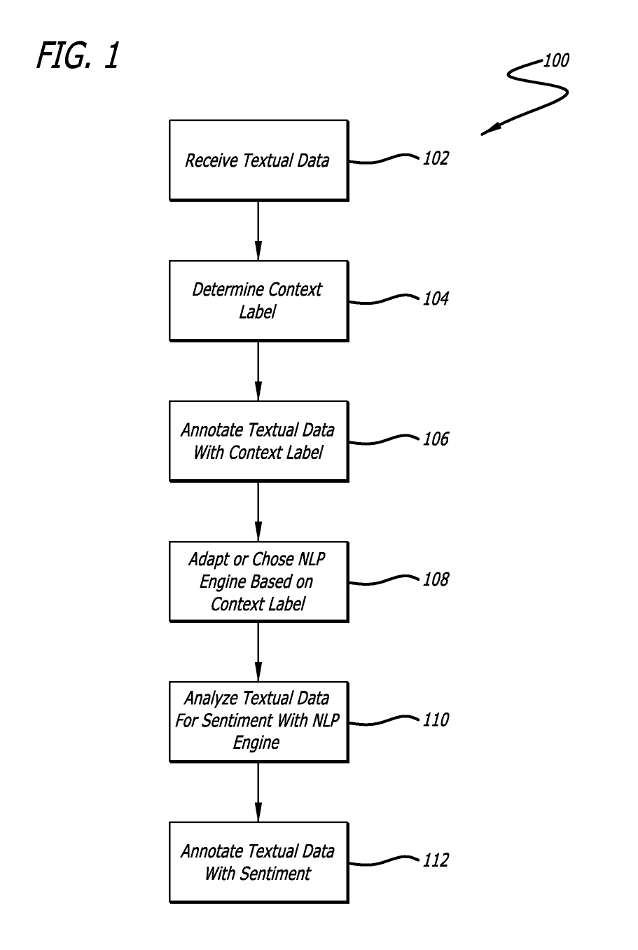

FIG. 1 is a flow chart illustrating an exemplary method 100 that may be performed by a computer system for determining sentiment from textual data while accounting for context of the textual data. At box 102 the processor of the computer system may be configured to receive or retrieve textual data for analysis. Textual data may be any electronically stored text, which may include, but is not limited to, text from social media posts, electronic document containing text, text from webpages, voice to text recordings, electronic books or magazines, and the like. The data may be received or retrieved by a processor of the computer system from any non-transitory computer-readable medium storing textual data through a data connection such as a bus, internet connection, or any other wired or wireless means of data transfer.

At box 104 a processor may be configured using programming commands to analyze the textual data and identify one or more context labels that may be associated by the processor with the textual data to categorize the textual data. The context labels may be entered by an operator into a memory addressable by the processor, or they may predetermined and stored in the memory in a database from which they may be retrieved by the processor, and may include labels for broad classifications such as sports, crime, music, television, movies, news, and/or politics. Context labels may be based on newspaper categorizations such as front page, sports, entertainment, business, technology, health, and/or science. Context labels can also be used to differentiate words with multiple meanings, for example “broncos” as a sports team versus “broncos” as animals. One of ordinary skill in the art will recognize the many different possible context labels that may be used to categorize textual data, all of which are contemplated herein.

In one embodiment, the processor may identify predetermined context labels by matching keywords and/or phrases within the textual data with a dataset. The system may include one or more databases stored in one or more memories that are accessible by the processor that contain sets of keywords and/or phrases that are linked to each context label. For example a word set for context label “sports” may include the words such as “goal,” “shoot,” “baseball,” “basketball,” “free throw,” and the like. The word set may also include the names of players of a sport, team names, city names, and other words that identify with a sport. The word set may also include phrases and/or regular expressions. The term “regular expression” is a term of art in the computer programming field relating to a sequence of characters that form a search pattern. Regular expressions may use non-alphanumeric characters (also known as special characters) that conduct character matches based on certain rules. The special characters allow for a regular expression to represent several combinations of character strings and/or add other useful search criterion or rules to a search request. For example, in some regular expression matching systems the symbol “*” represents a repeated character match and the symbol “.” represents any character. In this example, the regular expression “h.*t” would search for any character strings that start with an “h,” end with a “t,” and are separated by any number of characters. In one embodiment, a computer system may build and/or add to sets of keywords and/or phrases for each context label from news articles within each category. Keyword/regular expression/phrase sets for each context label may be updated daily with recent publications. One of ordinary skill in the art would recognize that there are many ways to update and/or create word sets for a context label, all of which are contemplated here within.

The processor of the computer system may be configured through appropriate software commands to conduct regular expression matches on textual data using the set of words and/or phrases in the database that are linked with the corresponding context labels. In one embodiment, when identifying context labels for textual data, the processor may be programmed to associate a confidence score with the context labels. For example, the computer system's processor or processors may identify a phrase “rangers arrested” in the textual data and flag this as a sports context with low confidence as this may be a story about a sports team or may be about rangers at a national park. An identified phrase of “rangers pitcher arrested”, however, would receive a high confidence rating as being related to a sports context. The processor may then compare this confidence score against a threshold value to determine if the label should be used in subsequent processing or if it should be ignored.

In another embodiment, the value of the confidence score may be affected by the type of linguistic feature used to label the context. Linguistic features of textual data cover a variety of characteristics of human language, including but not limited to syntactic structure; morphological structure; phonological sound patterns such as rhyme, rhythm and meter; textual indicators of phonetic characteristics such as stress, duration, intensity and tone; and lexical and phrasal semantic features such as sense, denotations, connotations, and presuppositions. Pragmatics and discourse analysis may be used to combine cultural and situational knowledge with language-internal linguistic features to aid in interpreting meaning from text. This may include but is not limited to textual reflexes of emotion, cultural references, discourse implicatures, body language, and the like.

When determining a confidence score in one example, phrases could be given a higher weight than a single word. In another example the confidence score could be higher if a word in the phrase is being used as a noun instead of a verb. In yet another example, an identified entity such as a sports team or player may give higher confidence than simply words that may often be associated with a sporting event such as ‘soccer’. Words that have can create mistaken contexts, such as ‘points’ or ‘goal’ may contribute a small confidence score.

In yet another embodiment, confidence levels may be determined by the processor by analyzing the textual data and determining or calculating the number of keywords and/or phrase matching between the textual data and a set of words for a context label. Words, phrases, and regular expression matches may be given different confidence scores.

At box 106, the textual data may be annotated by the processor with the identified context label. In one embodiment context labels may be ranked by the processor by their importance. The importance ranking of the context labels may be predetermined or user created and/or modified. For example, a user may decide that a ‘news’ context is always more important than a ‘sports’ context. The processor then utilizes this importance in its analysis of the textual data. In instances where multiple context labels are identified for textual data, the processor may use all the labels, some of the labels, or select a single label based on the importance and confidence of the labels to be used in its analysis.

In an alternative embodiment, the processor may be programmed to select the context label with the highest correlation of keywords and/or phrases or linguistic features. For example, a processor that determines that a textual data contains two words matching a sports context label word set and one word for an entertainment context label word set may mark or flag the textual data with the sports context label. In this example, the correlation value is based on the number of matches. In an alternative embodiment, the correlation value may be the sum of the weighted values for each word/phrase/regular express. Other alternative methods to determine correlation would be apparent to one of ordinary skill in the art and are contemplated here within.

In yet another alternative embodiment a weighting system may be used for choosing a context label for textual data. A computer system utilizing a processor programmed using appropriate commands may provide weighting or confidence values for each context label based on the correlation value between keywords/phrases/regular expressions or linguistic features in a context label word set and the words in the textual data. Context labels with higher levels of correlation may be given more weight in the processor's analysis. Another weighting value may also be assigned by the processor to context labels based on a ranking system or the importance of each context label. More important or higher ranked context labels may be given more weight. In one embodiment a user may set values and rankings for context labels by inputting information related to the values and rankings into the processor or a memory accessible by the processor. The combined weighting scores may be accessed by the processor during its analysis to determine the context label the textual data receives. In one embodiment, the weighting or the contribution of the weight provided by the computer system for correlation of words and/or context label importance may be user created and/or adjusted.

The computer system's processor may also be programmed using appropriate commands to select, adapt, choose, or apply an NLP engine at box 108 to determine the specific context label to be assigned to the textual data. For example, an NLP engine that uses keywords sets to identify sentiment may have different sets of key words depending on the context label. An NLP engine adapted, optimized, augmented and/or selected for sentiment analysis on textual data with a “sports” context label may identify certain linguistic features and/or key words as positive sentiment that would normally be negative sentiment for another context label, such as crime. For example keywords such as “burns”, “crushes”, and “destroys” may be negative in the context of crime, but positive in the context of sports. In one embodiment the system may have separate NLP engines for each context label. In an alternative embodiment, a general sentiment determining NLP engine may be used, and the resultant sentiment may be augmented based on the context label and the keywords and/or phrases used to determine the sentiment.

It will be understood that, in the context of this description, that an NLP engine is a software program that controls a processor to parse and analyze textual data so as to extract desired information from the textual data. In essence, the NLP engine transforms a stream of textual data into a collection of information data elements that can then be categorized and analyzed as described throughout this description of the invention. As stated above, the various embodiments of the invention may utilize one or more NLP engines, which may run on a single server or processor, or may run on multiple servers or processors.

The context adapted, optimized, augmented, and/or selected NLP engine analyzes the textual data for sentiment determination, such as positive, negative, or neutral sentiment at box 110. In an alternative embodiment, multiple levels of sentiment may be used, such as ‘strongly positive’, ‘positive’, ‘negative’, ‘strongly negative’, and neutral. In yet another alternative embodiment, a general all-purpose sentiment analyzing NLP engine may determine sentiment, and the resulting sentiment may be changed based on the context label and the keywords and/or phrases used by the NLP engine.

The system at box 112 may annotate the textual data with the determined sentiment. According to one embodiment, the textual data and sentiment may be held in separate data fields within one or more databases. Alternatively, the sentiment may be appended by the processor through comma separation. In yet another embodiment, textual data and sentiment may be linked through pointers, unique identifiers, data addresses and the like. In yet another alternative, the textual data may be annotated by the processor with the sentiment. One of ordinary skill in the art will recognize the many different ways sentiment data may be linked, annotated or appended to textual data, all of which are contemplated here within.

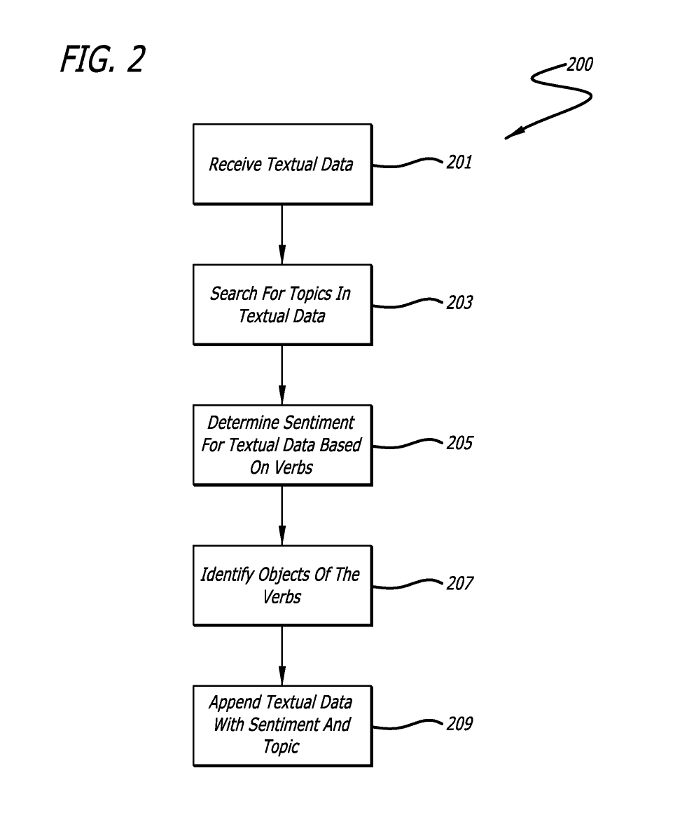

FIG. 2 is a flow chart illustrating an exemplary method 200 which may be conducted by a computer system having one or more processors programmed with appropriate software commands for determining context specific sentiment from textual data by identifying parts of speech. At box 201 the system may receive or retrieve textual data for analysis. Textual data may include, but is not limited to, data from social media posts, text documents, text from webpages, voice to text recordings, electronic books or magazines, and the like.

At box 203 the processor may be programmed to search within the textual data for a topic. Topics may be an event, person, item, subject, or any specific object that may be of interest. Topics may be sub-categories or elements of a context classification. According to one embodiment, topics may be detected through keyword and/or regular expression matching and/or searching linguistic features of the text. A topic may have a set of keywords/phrases/regular expressions associated with the topic. In another case, the topic of the data may be determined by the structure of the sentence. Topics may be identified by instructing a processor to search for matching words from a topic word set with the textual data. According to one embodiment, users may augment, edit, or provide the word set for one or more topics. Other methods of topic detection will be readily apparent to one of ordinary skill in the art, and are all contemplated here within.

At box 205 the system may determine a sentiment for the textual data with an NLP engine programmed using software commands to identify parts of speech that relate to sentiment. As described above, the NLP engine analyzes the textual data and extracts information data elements, in this embodiment, specific words, phrases or other speech elements that relate to sentiment. In one embodiment, the parts of speech used to determine sentiment may be verbs. In another embodiment, the NLP engine may determine multiple sentiments for the textual data. The NLP engine may determine a sentiment associated with the textual data from one or more verbs found by the NLP engine in the textual data and provide both the verb and the sentiment. For example, in analyzing the textual data “the Broncos® demolished the Seahawks®,” an NLP engine may identify the verb “demolished” and associate that verb with negative sentiment.

At box 207 the system may identify the one or more objects of the one or more verbs and which topic or topics the object or objects are related to. For example, a user of the system or the system itself may have labeled all text data as being related to the topic “Broncos” at box 203. With this information, the system may take an exemplary textual data such as “the Broncos® demolished the Seahawks®” and identify “Broncos®” as the subject of the topic, and that the “Broncos®” are taking action against another entity, the “Seahawks®”. The NLP engine may further then identify the verb “demolished” as indicating sentiment. The processor further may determine that the topic of the stream is performing the demolishing, so the sentiment for this text example in a topic about the “Broncos” is expressing positive sentiment. In an alternative embodiment, the NLP engine may identify the object of the word that is carrying the sentiment, in this case demolished. The NLP engine may label “the Seahawks” as being the object of the sentiment. The processor may then determine the text data as having negative sentiment to the Seahawks®. In this case the sentiment changes from positive to negative depending on the topic of the data and/or the object of the sentiment.

At box 209, the textual data may be appended with the one or more identified topics and correlating sentiment determinations by the processor. Continuing with the textual data example “the Broncos® demolished the Seahawks®,” the textual data would be appended, associated, or linked by the processor with the topic “Seahawks®” determined at box 203 and negative sentiment determined at box 205.

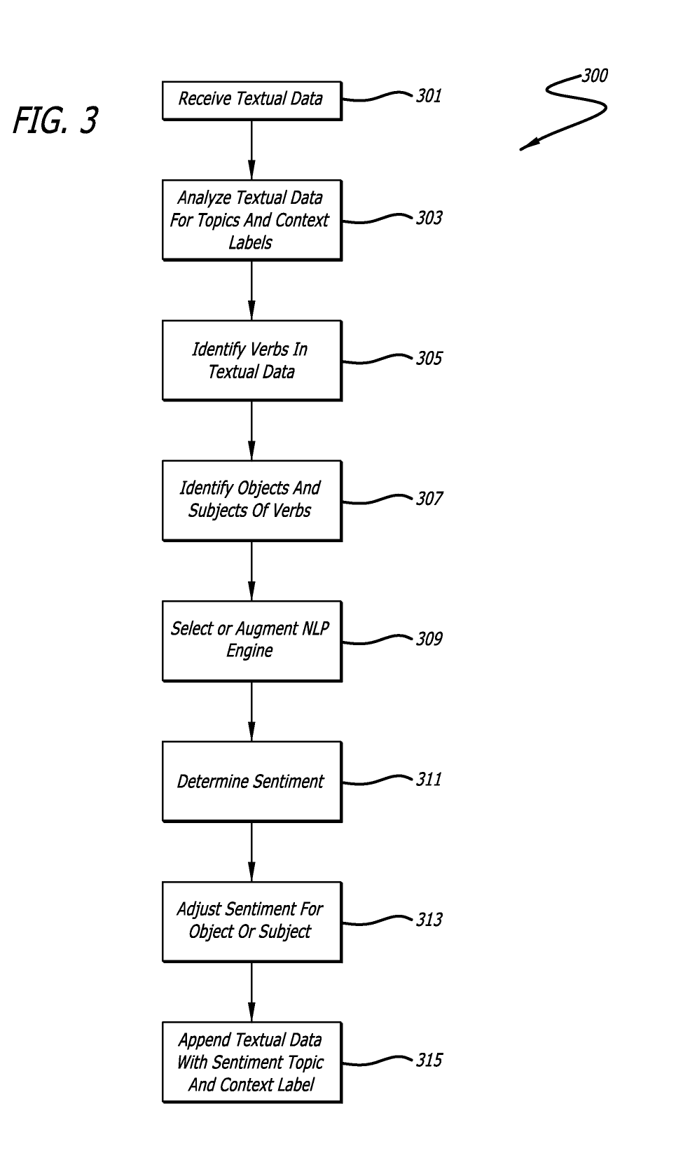

In yet another alternative embodiment a system for determining sentiment may use both context labels and verb, subject, and object analysis. FIG. 3 is a flow chart depicting an exemplary method 300 that may be implemented by a computer system having one or more processors programmed with appropriate software commands to determine sentiment for textual data while accounting for context and verb, subject, and object analysis.

At box 301 the system may receive textual data. Textual data may be any electronically stored text, which may include, but is not limited to, text from social media posts, electronic documents containing text, text from webpages, voice to text recordings, electronic books or magazines, and the like. The data may be received or retrieved from any non-transitory computer-readable medium storing textual data through a bus, internet connection, or any other wired or wireless means of data transfer.

At box 303, the system may analyze textual data for context labels. The context labels may be predetermined and may include labels such as sports, crime, music, television, movies, news, and/or politics. One of ordinary skill in the art would recognize the many different possible context labels that may be used to categorize text data, all of which are contemplated herein.

In this embodiment, the processor, at box 305, identifies one or more verbs within the textual data. In one embodiment, an NLP engine programmed to detect verbs based on key linguistic features may be used. Labeling parts of speech in text documents can be done with many standard available libraries in various programming languages such as NLTK®, the Stanford NLP software, or Apache OpenNLP®.

At box 307 the system may use a processor programmed to identify the subjects and/or objects associated to each verb and which topic or topics the object or objects are related to. Topics may be an event, person, item, subject, or anything that may be of interest. There may be one or more keywords or phrases that identify an object or subject to a topic. Topics may be sub-categories or elements of a context classification. According to one embodiment, topics may be detected by programming a processor to conduct keyword and/or regular expression matching and/or searching of the textual data. A topic may have a set of keywords/phrases/regular expressions associated with the topic. Topics may be identified by matching words from a topic word set with the object and/or subject. According to one embodiment, users may augment, edit, or provide the word set for one or more topics. Other methods of topic detection will be readily apparent to one of ordinary skill in the art, and are all contemplated here within.

At box 309 the processor or processors of the system may adapt, optimize, augment, and/or select an NLP engine for detecting sentiment for a particular context label.

At box 311 the processor or processors of the system may be programmed to determine the sentiment of each verb or verb phrase in the textual data using the NLP engine that has been adapted, optimized, augmented, and/or selected at box 305.

At box 313 the system may adjust the sentiment determined by the processor depending on whether the sentiment is applied to a subject or object of a verb.

At box 315 the processor may append the textual data with the sentiment, topic, and context label determinations.

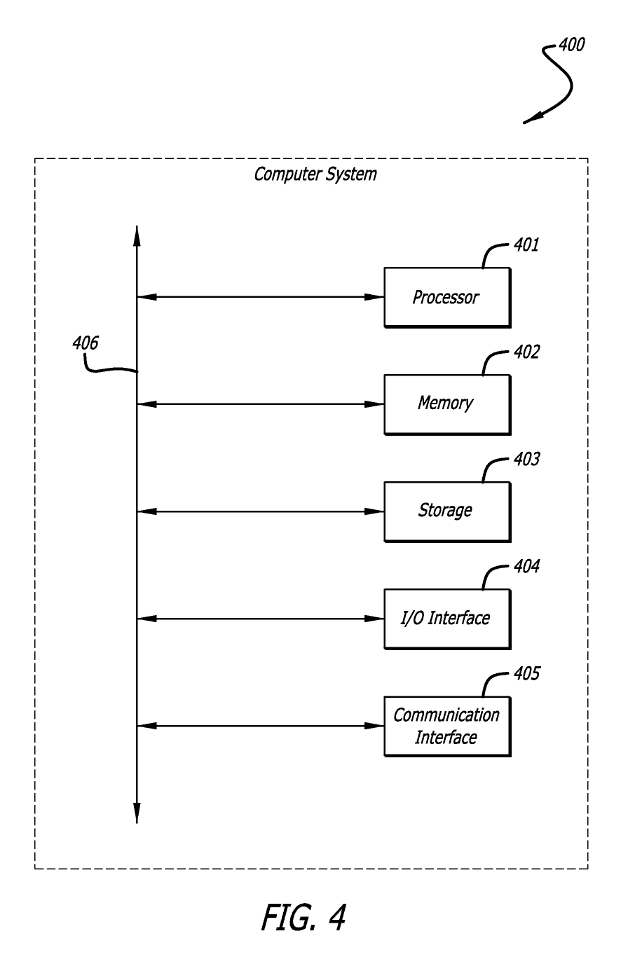

FIG. 4 illustrates an exemplary computer system 400 which may be programmed or configured with software commands to carry out the various embodiments of the present invention. Computer system 400 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, and the like. Computer system 400 may also be a combination of multiple forms. Computer system 400 may include one or more computer systems 400, be unitary or distributed, span multiple locations, span multiple systems, or reside in a cloud (which may include one or more cloud components in one or more networks).

In an embodiment, computer system 400 may include one or more processors 401, memory 402, storage 403, an input/output (I/O) interface 404, a communication interface 405, and a bus 406. Although this disclosure describes and illustrates a particular computer system having a particular number of particular components in one particular arrangement, this disclosure contemplates other forms of computer systems having any suitable number of components in any suitable arrangement.

In one embodiment, processor 401 includes hardware for executing instructions, such as those produced by software programs. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, processor 401 may retrieve the instructions from an internal register, an internal cache, memory 402 or storage 403; decode and execute them; and then write one or more results to an internal register, an internal cache, memory 402, or storage 403. In one embodiment, processor 401 may include one or more internal caches for data, instructions, or addresses. Memory 402 may be random access memory (RAM), static RAM, dynamic RAM or any other suitable memory. Storage 403 may be a hard drive, a floppy disk drive, flash memory, an optical disk, magnetic tape, or any other form of storage device that can store data (including instructions for execution by a processor).

In a typical embodiment, storage 403 may be mass storage for data or instructions which may include, but is not limited to, a HDD, solid state drive, disk drive, flash memory, optical disc (such as a DVD, CD, Blue ray, and the like), magneto optical disc, magnetic tape, or any other hardware device which stores may store computer readable media, data and/or combinations thereof. Storage 403 maybe be internal or external to computer system 400 and may be located remotely from computer system 400, but in communication with computer system 400, or accessible by computer system 400.

In another embodiment, input/output (I/O) interface 404 includes hardware, software, or both, for providing one or more interfaces for communication between computer system 400 and one or more I/O devices. Computer system 400 may have one or more of these I/O devices, where appropriate. As an example but not by way of limitation, an I/O device may include one or more mouses, keyboards, keypads, cameras, microphones, monitors, display, printers, scanners, speakers, cameras, touch screens, trackball, and the like.

In still another embodiment, a communication interface 405 includes hardware, software, or both which provides one or more interfaces for communication between one or more computer systems or one or more networks. Communication interface 405 may include a network interface controller (NIC) or a network adapter for communicating with an Ethernet or other wired-based network or a wireless NIC or wireless adapter for communication with a wireless network, such as a WI-FI network. In one embodiment, bus 406 includes hardware, software, or both coupling components of a computer system 400 to each other.

While particular embodiments of the present invention have been described, it is understood that various different modifications within the scope and spirit of the invention are possible. The invention is limited only by the scope of the appended claims.

We claim:

1. A computer implemented method for analyzing textual data to determine a context aware sentiment, comprising:
receiving textual data from a social media server;
analyzing the received social media data to identify a context for the received textual data;
selecting a natural language processor based on the identified context of the received textual data;
analyzing the textual data using the natural language processor to determine a sentiment to be associated with the textual data; and
storing the determined sentiment on a non-transitory computer readable medium.

2. The method of claim 1 wherein identifying a context for the textual data comprises conducting a match between the textual data and a keyword associate with the context.

3. The method of claim 1 wherein storing the determined sentiment on the non-transitory computer readable medium comprises associating the textual data with the determined sentiment.

4. The method of claim 3 wherein storing the determined sentiment on the non-transitory computer readable medium comprises associating the textual data and determined sentiment with a context label.

5. A computer implemented method for analyzing textual data to determine a context aware sentiment, comprising:
receiving textual data from a server;
analyzing the received textual data to determine a sentiment associated with the received textual data and a speech element extracted from the received textual data;
analyzing the received textual data to identify an object associated with the speech element within the received textual data associated with the sentiment;
matching the object to a topic; and
storing the topic and the determined sentiment on a non-transitory computer readable medium.

6. The method of claim 5 wherein the speech element is a verb or a verb phrase and the object is the object of the verb or verb phrase.

7. The method of claim 5 wherein matching the object to the topic comprises conducting a regular expression match on a keyword set associated with the topic.

8. The method of claim 5 further comprising identifying a subject within the textual data associated with the determined sentiment from the speech element.

9. The method of claim 8 further comprising, matching the subject to a second topic.

10. The method of claim 9 further comprising, changing the sentiment to a second sentiment which applies to the subject and storing the second sentiment on a non-transitory computer readable medium.

11. The method of claim 10 wherein storing the second sentiment on the non-transitory computer readable medium comprises annotating the textual data with the subject and second sentiment.

12. The method of claim 11 wherein the speech element is a verb or verb phrase and the object is the object of the verb phrase and the subject is the subject of the verb.

13. A computer implemented method for context aware sentiment analysis on textual data comprising:
receiving textual data from a server;
identifying a context for the received textual data;
modifying a natural language processor to identify a sentiment value associated with the received textual data in accordance with the context;
determining the sentiment value and associated parts of speech with the natural language processor;
identifying an object within the textual data associated with the sentiment from the associated parts of speech;
matching the object to a topic; and
storing the topic, object, and sentiment on a non-transitory computer readable medium.

14. The method of claim 13 wherein the associated parts of speech is a verb or verb phrase and the object is the object of the verb.

15. The method of claim 13 wherein matching the object to a topic comprises conducting a regular expression match on a keyword set for the topic.

16. The method of claim 15 further comprising, identifying a subject within the textual data associated with the sentiment from the associated parts of speech.

17. The method of claim 16 further comprising, changing the sentiment to a second sentiment which applies to the subject and storing the second sentiment on a non-transitory computer readable medium.

18. The method of claim 17 wherein identifying a context for the textual data comprises conducting a regular expression match between the textual data and a keyword set for the context.

19. The method of claim 18 wherein storing the topic, object, and sentiment on a non-transitory computer readable medium comprises annotating the textual data with the topic, object and sentiment.

20. The method of claim 18 further comprising annotating the textual data with the subject.

21. A system for determining sentiment from textual data comprising:
a non-transitory computer readable medium storing textual data;
a processor executing programming instructions to:
identify a context for the textual data,
select a natural language processor based on the identified context,
analyze the data using the natural language processor to determine a sentiment value, and
store the determined sentiment on the non-transitory computer readable medium.

22. The system of claim 21, wherein the processor executes programming instructions to annotate the textual data with the determined sentiment and to store the determined sentiment and annotated textual data on the non-transitory computer readable medium.

23. The system of claim 22 wherein the processor executes programming instructions to annotate the textual data and determined sentiment with a context label and to store the annotated textual data, determined sentiment and context label on the non-transitory computer readable medium.
